(19) United States
(12) Patent Application Publication
(10) Pub. No.: US 2026/0011709 A1
(43) Pub. Date: Jan. 8, 2026

(54) System and Method for Battery Electrode Fabrication

(71) Applicant: AM Batteries, Inc., Billerica, MA (US)

(72) Inventors: Peter DiMaggio, Lowell, MA (US); Omri Flaisher, Litchfield, NH (US); Jay Jie Shi, Acton, MA (US)

(73) Assignee: AM Batteries, Inc., Billerica, MA (US)

(21) Appl. No.: 19/135,257

(22) PCT Filed: Dec. 6, 2023
(86) PCT No.: PCT/US2023/082635

§ 371 Date: Jun. 3, 2025

Related U.S. Application Data
(60) Provisional application No. 63/430,478, filed on Dec. 6, 2022.

(51) Int. Cl. H01M 4/04; B05B 12/20; B05D 1/06; B05D 3/12; H01M 50/119

(52) U.S. Cl. CPC H01M 4/0419; B05B 12/20; B05D 1/06; B05D 3/12; H01M 4/045; H01M 50/119

(57) ABSTRACT

An example electrode for a battery is provided, as well as a system and method for fabrication of an electrode for the battery. The electrode includes an electrically conductive substrate defining a first surface and a second surface. The electrode includes a pattern of an active material coating formed on at least one of the first or second surface of the electrically conductive substrate. The pattern includes coated and uncoated areas formed by depositing an active material dry powder onto at least one of the first surface or the second surface of the electrically conductive substrate via electrostatic spray deposition during movement of the electrically conductive substrate, and selectively removing at least a portion of the active material dry powder from at least one of the first surface or the second surface of the electrically conductive substrate with a powder removing assembly to create the uncoated areas of the pattern.

### CROSS-REFERENCE TO RELATED APPLICATIONS

This application claims priority to and the benefit of U.S. Provisional Patent Application No. 63/430,478, filed on Dec. 6, 2022. The entire content of the foregoing provisional application is incorporated herein by reference in its entirety.

### BACKGROUND

A variety of batteries are available in the industry for different uses. Lithium-ion (Li-ion) batteries have generally become the predominant type of battery used in portable consumer electronics and electric vehicles. Fabrication of Li-ion batteries involves numerous steps, each of which can affect the quality of the battery itself, as well as the cost involved in manufacturing the battery. A conventional manufacturing process generally includes formation of an electrode slurry having an active material, a conductive additive, and a binder, mixed in an organic solvent, and the electrode slurry is applied to a metal foil material. Once applied to the foil material, the solvent is dried out or evaporated while the active electrode mixture remains attached to the metal foil material surface. In some instances, the solvent may be toxic and can necessitate additional steps for handling/discarding that increase the overall cost of the manufacturing process. The cost of removing the solvent from the coated material on the metal foil therefore involves an additional step that also increases the overall cost of the manufacturing process.

An alternative manufacturing technique used in the industry is electrostatic spray deposition (ESD), which is a solvent-free manufacturing process for electrode coating for Li-ion batteries. (See, e.g., B. Ludwig et al., Solvent-Free Manufacturing of Electrodes for Lithium-ion Batteries, Sci. Rep. 6, Article No. 23150, doi: 10.1038/srep23150 (2016); M. Wang et al., The Influence of Polyvinylidene Fluoride (PVDF) Binder Properties on LiNi_{0.33}Co_{0.33}Mn_{0.33}O₂ (NMC) Electrodes Made by a Dry-Powder-Coating Process, J. Electrochem. Soc., Vol. 166, No. 10, A2151 (2019); H. Abe et al., Electrostatic Spray Deposition for Fabrication of Li-ion Batteries, Transactions of JWRI, Vol. 44, No. 2 (2015); and U.S. Pat. No. 10,547,044). Rather than relying on a solvent mixture, the ESD process uses a powder of the active electrode mixture which is applied to the metal foil material. By removing the solvent from the mixture and the drying step from the manufacturing process, the overall process is simplified and becomes more economic, resulting in a viable alternative for large-scale manufacturing. In particular, the solvent-free electrode coating technology is an attractive alternative to traditional manufacturing since it can significantly reduce energy consumption in the manufacturing process and thus significantly reduce the manufacturing cost of batteries.

In electrode manufacturing, the concepts and fundamentals of web handling are important in generating an acceptable product that is within required specifications and of the correct geometry. This is equally true for the ESD process as it is for the conventional slurry cast process. FIG. 1 is a diagrammatic, generic overview of a traditional dry powder ESD coating system 10, highlighting the features of a web handling system. The central part of the system 10 is the web 12 itself with two sides (e.g., side A—the top side, and side B—the bottom side), also referred to in the industry as a current collector, foil, or substrate. The web 12 passes through a coating chamber 14 along direction 16 in a continuous manner, with the ESD processing occurring within the coating chamber 14 such that the web 12 is coated with the active material mixture (not shown). The web 12 then passes in-between and through calender rolls 18, 20 to densify the active material mixture coating on the web 12. Eventually, the web 12 is rolled onto a core at the rewind station, ready to be slit and assembled into a Li-ion battery. The direction 16 in which the web 12 travels is commonly known in industry as the Machine Direction (MD), while the orthogonal axis 22 is known as the Cross Direction (CD).

The electrode formed by the ESD coating system 10 generally results in at least one uncoated region along which conductive tabs can be welded to the electrode for incorporation of the electrode into a battery. However, the location of the uncoated region is typically limited due to the active material powder being applied to the web 12. For example, in conventional slurry cast electrode manufacturing, formation of these types of uncoated regions can be performed by controlling the deposition of the slurry onto the web using a slot die. In such conventional process, the slurry has adequate viscosity such that it can be precisely applied to the web in the desired coating region while avoiding the edge tab regions. A sharp edge between the active material and the edge tab is generally formed to reduce the risk of cathode-to-anode capacity mismatching which may lead to reduced cycle life or an internal short circuit. For the dry ESD process, the powders cannot be dispensed in such a controlled manner since the dry particles' momentum and trajectory is easily altered by external forces, such as drag and/or electromagnetic fields. Due to the inherent process differences between wet slurry and dry powders, the slurry cast electrode manufacturing solution to the problem is not applicable. The desired location and number of uncoated regions in an ESD process is therefore limited.

Turning to the web converting industry as a whole does not provide readily available solutions to the limitations of the conventional slurry cast electrode manufacturing process or the conventional ESD process. There are several ways coatings are controlled or removed from a web. However, the aim of such conventional means is to control coating thickness and uniformity through either metering or using a blade. These options do not lend themselves to introducing or forming a pattern in the coating with varied thickness across the width of the web (e.g., uncoated areas formed in-between coated areas). Existing solutions in the industry are generally applied to aqueous or liquid-based coating material. Few web handling applications coat dry powder onto a moving web. The nature of dry powder introduces new challenges not met by slurry cast methods and the current web handling industry.

### SUMMARY

In accordance with embodiments of the present disclosure, an exemplary system for battery electrode fabrication is provided. The system can be used to produce an electrode that has a specific pattern of areas coated in active material and uncoated areas, with sharp edges between the two. In accordance with embodiments of the present disclosure, an exemplary electrode for a battery is provided. The electrode includes an electrically conductive substrate defining a first surface and an opposing second surface. The electrode includes a pattern of an active material coating formed on at least one of the first surface or the second surface of the electrically conductive substrate. The pattern includes coated and uncoated areas. The pattern of the coated and the uncoated areas is formed by depositing an active material dry powder onto at least one of the first surface or the second surface of the electrically conductive substrate via electrostatic spray deposition during movement of the electrically conductive substrate, selectively removing at least a portion of the active material dry powder from at least one of the first surface or the second surface of the electrically conductive substrate with a powder removing assembly to create the uncoated areas of the pattern, and bonding the active material dry powder to at least one of the first surface or the second surface of the electrically conductive substrate to create the coated areas of the pattern.

In some embodiments, the electrically conductive substrate can be an aluminum foil substrate. In some embodiments, the first and second surfaces of the electrically conductive substrate can be substantially planar or flat. In some embodiments, the pattern of the coated and uncoated areas can be formed by simultaneously depositing the active material dry powder onto both the first surface and the second surface of the electrically conductive substrate via electrostatic spray deposition, simultaneously selectively removing at least the portion of the active material dry powder from both the first surface and the second surface of the electrically conductive substrate with the powder removing assembly to create the uncoated areas of the pattern on both the first surface and the second surface.

In some embodiments, the powder removing assembly can include a wiping mechanism configured to remove at least the portion of the active material dry powder from at least one of the first surface or the second surface of the electrically conductive substrate. In some embodiments, the powder removing assembly can include a masking mechanism configured to cover an area of the electrically conductive substrate corresponding with the uncoated areas of the pattern. In some embodiments, the pattern can include the uncoated areas in a cross direction of the electrically conductive substrate. In some embodiments, the powder removing assembly can include a wiping mechanism configured to disturb or move at least a portion of the active material dry powder from at least one of the first surface or the second surface of the electrically conductive substrate, and can further include a vacuum configured to remove the disturbed or moved active material dry powder.

In accordance with embodiments of the present disclosure, an exemplary system for battery electrode fabrication is provided. The system includes a coating assembly configured to deposit an active material dry powder onto at least one of a first surface or an opposing second surface of an electrically conductive substrate via electrostatic spray deposition while the electrically conductive substrate moves or passes through or under the coating assembly. The system includes a powder removing assembly configured to selectively remove at least a portion of the active material dry power from at least one of the first surface or the second surface of the electrically conductive substrate to create a pattern of the active material dry powder having coated and uncoated areas. The system includes a bonding assembly configured to bond the active material dry powder to at least one of the first surface or the second surface of the electrically conductive substrate.

In some embodiments, the electrically conductive substrate can be an aluminum foil substrate. In some embodiments, the pattern can include the uncoated areas oriented along a cross direction of the electrically conductive substrate. In some embodiments, the pattern can include the uncoated areas oriented along a machine direction of the electrically conductive substrate. In some embodiments, the powder removing assembly can include a masking mechanism incorporated into the coating chamber. In some embodiments, the powder removing assembly can include a wiping mechanism disposed distally from the coating chamber. In some embodiments, the powder removing assembly can include both a masking mechanism incorporated into the coating chamber and a wiping mechanism disposed distally from the coating chamber.

In some embodiments, the coating assembly can be configured to simultaneously deposit the active material dry powder on both the first surface and the second surface of the electrically conductive substrate, and the powder removing assembly can be configured to simultaneously selectively remove at least the portion of the active dry powder from both the first surface and the second surface of the electrically conductive substrate to create the pattern of the active material dry powder having coated and uncoated areas on both the first surface and the second surface.

In some embodiments, the powder removing assembly can be a wiping mechanism including a vacuum including a nozzle disposed above at least one of the first surface or the second surface of the electrically conductive substrate and configured to selectively remove the active material dry powder to form the uncoated areas of the pattern. In some embodiments, the powder removing assembly can be a wiping mechanism including an angled ramp configured to direct the active material dry powder off of the electrically conductive substrate to form the uncoated areas of the pattern. In some embodiments, the powder removing assembly can include a wiping mechanism including a ramp configured to disturb or move at least a portion of the active material dry powder from the electrically conductive substrate, and can further include a vacuum configured to remove the disturbed or moved active material dry powder. In some embodiments, the powder removing assembly can be a wiping mechanism including a rotary slitter configured to form a slit in the active material dry powder to designate an edge of the uncoated areas to be formed in the active material dry powder. In some embodiments, the power removing assembly can be a wiping mechanism including a conveyor system with one or more belts configured to contact and remove the active material dry powder from the electrically conductive substrate.

In accordance with embodiments of the present disclosure, an exemplary method of battery electrode fabrication is provided. The method includes continuously passing an electrically conductive substrate through or under a coating assembly to deposit an active material dry powder onto at least one of a first surface or a second surface of the electrically conductive substrate via electrostatic spray deposition during movement of the electrically conductive substrate. The method includes selectively removing at least a portion of the active material dry powder from at least one of the first surface or the second surface of the electrically conductive substrate with a powder removing assembly to create a pattern of the active material dry powder having coated and uncoated areas. The method includes bonding the active material dry powder to at least one of the first surface or the second surface of the electrically conductive substrate with a bonding assembly.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the system for battery electrode fabrication, reference is made to the accompanying figures, wherein:

FIG. 1 is a diagrammatic view of a traditional electrostatic spray deposition (ESD) system;

FIG. 2 is a diagrammatic view of an electrode geometry formed by an exemplary system for battery electrode fabrication using an ESD process;

FIG. 3 is a diagrammatic view of an electrode geometry formed by an exemplary system for battery fabrication using an ESD process;

FIG. 4 is a diagrammatic view of an exemplary system for battery electrode fabrication using an ESD process including a powder removing assembly;

FIG. 5 is a diagrammatic view of an exemplary system for battery electrode fabrication using an ESD process including a powder removing assembly producing an uncoated pattern along a machine direction (MD) with a wiping mechanism;

FIG. 6 is a diagrammatic view of an exemplary system for battery electrode fabrication using an ESD process including a powder removing assembly producing an uncoated pattern along a cross direction (CD) with a wiping mechanism;

FIG. 7 is a diagrammatic view of an exemplary system for battery electrode fabrication using an ESD process including a powder removing assembly producing an uncoated pattern along a machine direction (MD) with a vacuum mechanism;

FIG. 8 is a diagrammatic view of an exemplary system for battery electrode fabrication using an ESD process including a powder removing assembly producing an uncoated pattern along a machine direction (MD) with a ramp mechanism;

FIG. 9 is a diagrammatic view of an exemplary system for battery electrode fabrication using an ESD process including a powder removing assembly producing an uncoated pattern along a machine direction (MD) with a slitter or rotary blade mechanism;

FIG. 10 is a diagrammatic view of an exemplary system for battery electrode fabrication using an ESD process including a powder removing assembly producing an uncoated pattern along a machine direction (MD) with a continuous conveyor mechanism;

FIG. 11 is a diagrammatic view of an exemplary system for battery electrode fabrication using an ESD process including a powder removing assembly producing an uncoated pattern along a machine direction (MD) with a masking mechanism;

FIG. 12 is a diagrammatic view of an exemplary system for battery electrode fabrication using an ESD process including a powder removing assembly producing an uncoated pattern along a machine direction (MD) with a conveyor mask mechanism;

FIG. 13 is a diagrammatic view of an exemplary system for battery electrode fabrication using an ESD process including a powder removing assembly producing an uncoated pattern along a machine direction (MD) with a stationary mask mechanism;

FIG. 14 is a diagrammatic view of an exemplary system for battery electrode fabrication using an ESD process with a web disposed in a vertical orientation;

FIG. 15 is a diagrammatic view of an exemplary system for battery electrode fabrication using an ESD process including a powder removing assembly producing an uncoated pattern along a machine direction (MD) on a bottom or B side of a web;

FIG. 16 is a diagrammatic view of an exemplary system for battery electrode fabrication using an ESD process including a powder removing assembly simultaneously producing an uncoated pattern along a machine direction (MD) on both top and bottom sides (A and B sides) of a web;

FIG. 17 is a diagrammatic view of a bottom or B side of an electrode formed by an exemplary system for battery electrode fabrication of FIGS. 15 and 16;

FIG. 18 is a diagrammatic view of an exemplary system for battery electrode fabrication using an ESD process with a powder removing assembly including both wiping and masking mechanisms;

FIG. 19 is a diagrammatic view of an exemplary system for battery electrode fabrication using an ESD process including a powder removing assembly producing an uncoated pattern along a machine direction (MD) with a wiping and vacuum mechanism;

FIG. 20 is a diagrammatic view of an exemplary system for battery electrode fabrication of FIG. 19; and

FIG. 21 is a diagrammatic view of an exemplary system for battery electrode fabrication using an ESD process including a powder removing assembly producing an uncoated pattern along a machine direction (MD) with a wiping and vacuum mechanism and an adjustable force for a blade.

### DETAILED DESCRIPTION

There are no conventional processes, mechanisms, or combinations of both, which, when creating a patterned coating, adequately accommodate the unique characteristics of electrostatically adhered particles to a grounded electrically conductive web. An electrostatically charged and deposited particle generally develops an “image” force to the conductive substrate based on the potential difference between the surface charge of the particle to the grounded substrate as well as the strength and direction of the electromagnetic field lines in which the particle travels. Some of the fundamental characteristics include the time-dependency of charge dissipation, which leads to a weakening of the electrostatic image force, the overall charge a particle can hold, and electric field line distortions due to phenomena such as faraday cage effects. The image force provides a temporary bonding between charged particles and the grounded substrate. The image force for bonding force is generally not strong, which allows particles bonding on the surface of substrate surface to be easily removed by mechanical wiping means to generate uncoated coating patterns described herein. Since the ESD coating process involves spraying dry powder(s) onto the electrically conductive web, it allows a masking mechanism to generate uncoated coating patterns. Such masking mechanism has not been used to develop a patterned coating in a continuous coating assembly. (See, e.g., Lee et al., Binder-assisted electrostatic spray deposition of LiCoO₂ and graphite films on coplanar interdigitated electrodes for flexible/wearable lithium-ion batteries, Journal of Power Sources, Volume 472, 228573 (Oct. 1, 2020)).

The exemplary system discussed herein provides a means for accommodating the unique characteristics of electrostatically adhered particles to a conductive web and forming unique patterns in the coating of the conductive web during the ESD process. In particular, the system provides means for fabricating an electrode to be incorporated into a Li-ion battery. The system includes a powder removing and/or directing assembly (referred to herein as a powder removing assembly) that allows for selective removal of powder from the web to generate a desired pattern of coated and uncoated areas of the web. The powder removing assembly can either remove powder applied to the web, direct/redirect powder applied to the web, combinations thereof, or the like. The powder removing assembly is therefore capable of wiping and/or masking, as discussed herein. This allows for customization of the location and number of edge or weld tab regions formed on the web. The system results in a simpler and more flexible electrode coating process, which allows for unique and customizable options in electrode manufacturing.

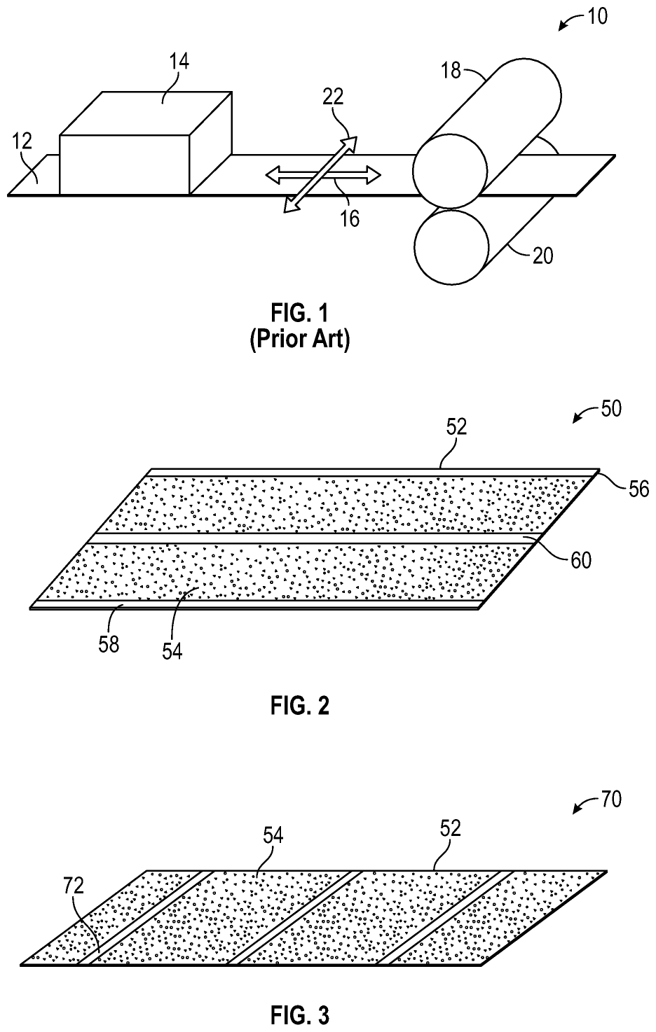

In particular, after the ESD process is complete, in order to fulfill the electrode's functional requirements, the final product needs to exhibit certain key geometries. FIGS. 2 and 3 provide diagrammatic representations of electrode geometries (called uncoated coating patterns herein) formed by an exemplary ESD system (discussed below). As shown in FIG. 2, the electrode 50 includes a web 52 (e.g., a conductive substrate, a current collector, or the like) and an active material coating 54 applied to the web 52. The active material coating 54 occupies most of surface area of the web 52. The coating 54 application illustrated in FIG. 2 includes edge tab regions 56-60 (e.g., weld tab regions). These regions 56-60 can be used in battery assembly to weld conductive tabs to the electrode 50 such that the electrode 50 can be electrically incorporated into the battery. The regions 56-60 can be formed on the sides of the coating 54 (e.g., regions 56, 58) and/or in an internal area of the electrode 50 (e.g., region 60). The uncoated regions 56-60 are formed along the machine direction (MD). FIG. 3 illustrates a substantially similar electrode 70, although edge tab regions 72 are formed in the cross direction (CD). The exemplary system allows for formation of multiple uncoated regions of the web 52, including one or more internal regions similar to region 60 and/or region 70. The location and number of uncoated regions can be customized based on the desired location of the conductive tabs. By introducing one, or several, edge tab regions, the electrode can be slit into multiple strips, allowing for higher production throughput. In some embodiments, the system can be configured to form uncoated coating patterns oriented only in the machine direction (MD), oriented only in the cross direction (CD), or both.

The system therefore provides flexibility and customization in the creation of the weld or edge tab regions during manufacturing of electrodes via ESD techniques with a moving electrically conductive web. The system ensures that the weld or edge tab regions are created without inducing any defects into the coating that may degrade the performance of the finished electrode. The resulting weld or edge tab area is free of any coating material. In addition, during formation of the weld or edge tab regions, the system does not induce any defects into the web (e.g., foil substrate), because such defects could potentially degrade the web's ability to successfully complete any downstream processing. In some embodiments, the system is capable of being operated continuously at the normal operating speed of the web formation. In some embodiments, the system operation can be adjusted to selectively create the uncoated regions on the web or selectively allow for full cover of the web. The system accommodates the particular behavior of electrostatically adhered particles, and allow for the reclamation of any uncoated powder. In particular, any powder removed from the web surface before bonding can be collected and reused for further coating of the same web or another web.

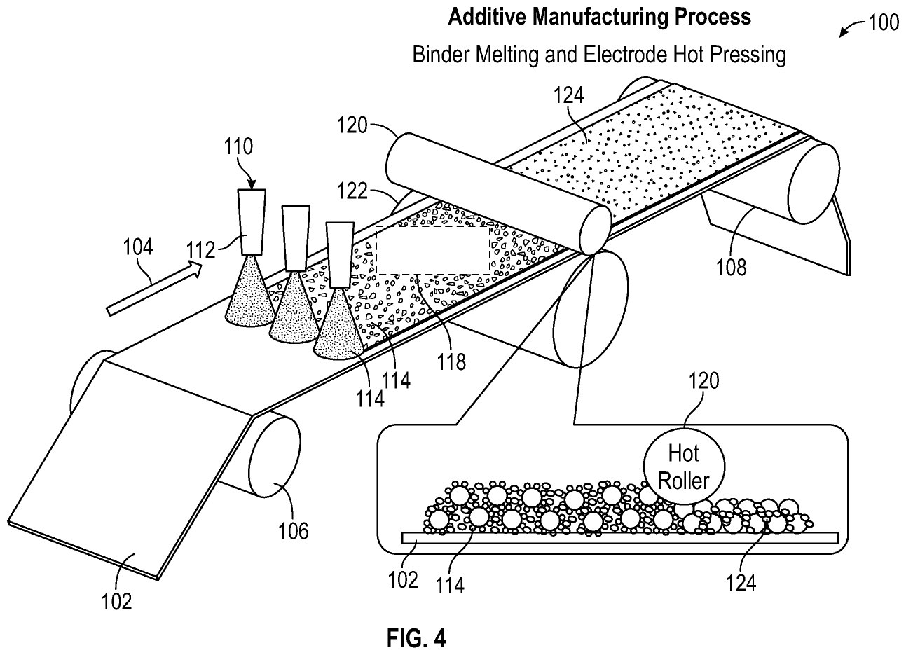

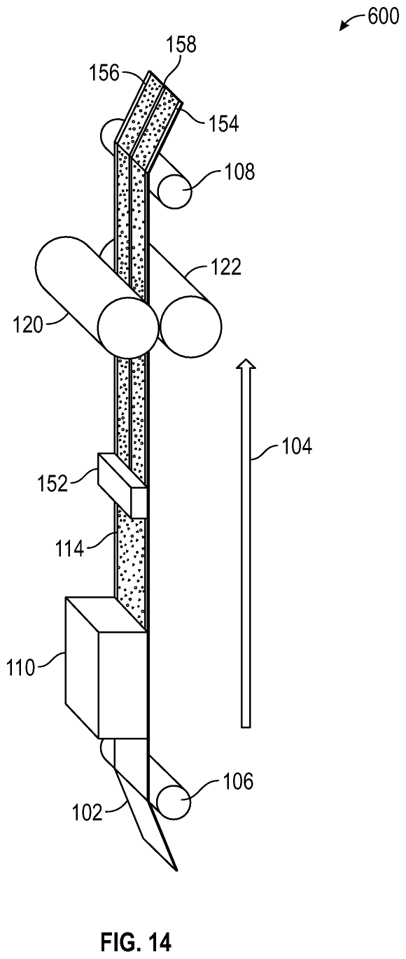

FIG. 4 is a diagrammatic view of an exemplary system 100 for battery fabrication using an ESD process. The system 100 includes a web 102 that travels along direction 104 (e.g., a machine direction) for coating. In some embodiments, the web 102 can be in the form of an aluminum foil substrate. The system 100 can include a roller 106 at a proximal end of the assembly, and a roller 108 at a distal end of the assembly. Both rollers 106, 108 can be disposed below the web 102 and in direct contact with the web 102 such that the web 102 can be maintained in a substantially taught configuration as it passes through the coating process. In some embodiments, additional rollers can be positioned below and/or above the web 102 to ensure the web 102 is maintained in the desired orientation for coating. As illustrated in FIG. 4, in some embodiments, the web 102 can be maintained in an orientation substantially parallel or parallel to a horizontal plane (e.g., the floor, or the like). In some embodiments, as illustrated in FIG. 14, the web 102 can be maintained in an orientation substantially vertical/perpendicular or vertical/perpendicular to a horizontal plane. In some embodiments, the web 102 can be maintained at a non-parallel or non-perpendicular orientation to a horizontal plane, e.g., any angle relative between a parallel and perpendicular orientation).

The system 100 includes a coating assembly 110 (e.g., a coating chamber) configured to apply a dry powder coating to one or more surfaces of the web 102. For example, the web 102 can include a top surface (e.g., the upwardly facing surface or side A of FIG. 4) and an opposing bottom surface (e.g., the downwardly facing surface or side B of FIG. 4). The coating assembly 110 can be configured to apply the dry powder coating to the top surface, the bottom surface, or both. In some embodiments, the coating assembly 110 can be used to apply the dry powder coating to one surface, and can be subsequently used to apply the dry powder coating to the opposing surface. In some embodiments, the coating assembly 110 can be used to apply the dry powder coating to both surfaces simultaneously. As such, it should be understood that any discussion herein regarding application of a dry powder coating to one surface of the web 102 can be similarly used to apply the dry powder coating to the opposing surface of the web 102.

The coating assembly 110 can be disposed in a spaced manner distally from the roller 106 to ensure that the continuously moving web 102 is in the horizontal orientation (or any desired orientation) before dry powder is applied to the top surface of the web 102. The coating assembly 110 can apply powder from one or more powder applicators such that electrostatically charged powder particles deposit on the grounded electrically conductive web 102. For example, in some embodiments, the coating assembly 110 can be disposed immediately distally from the roller 106 (e.g., from the central axis of the roller 106). In some embodiments, the coating assembly 110 can be in the form of multiple spray heads 112 positioned over the web 102 and configured to release the dry powder 114 over the web 102 for application to the top surface (or any surface(s)) of the web 102. In some embodiments, the coating assembly 110 can include a single spray head 112, or multiple spray heads 112. In some embodiments, the coating assembly 110 can be in the form of a roller that dispenses the powder onto the surface of the web 102, an air stream that carries the powder onto the surface of the web 102 in a controller manner, or the like. In some embodiments, alternative dry powder coating application structure(s) can be used.

Distally from the coating assembly 110, the system 100 includes a powder removing assembly 118 that can be selectively activated to remove dry powder 114 from specified areas of the web 102 to create a pattern of coated and uncoated regions on the surface(s) of the web 102 (e.g., top surface, bottom surface, or both). In some embodiments, the powder removing assembly 118 can be incorporated into the coating assembly 110. In some embodiments, the powder removing assembly 118 can be distally spaced from the coating assembly 110, as illustrated in FIG. 4. Because the bond between the web 102 and the dry powder 114 is not strong and only sufficient enough to maintain the position of the dry powder 114 on the web 102 until latter stages of processing, the powder removing assembly 118 is able to easily remove the dry powder 114 from the desired area(s) of the web 102 to create the desired coated/uncoated pattern along the surface of the web 102. The powder removing assembly 118 is disposed above the surface of the web 102 and can include various internal mechanisms and/or assemblies for removing the dry powder 114 from the web 102, examples of which are discussed below.

In some embodiments, the powder removing assembly 118 can continuously operate to continuously create one or more uncoated regions of the web 102. In some embodiments, the powder removing assembly 118 can be selectively actuated between an operating condition and a non-operating condition to selectively create the one or more uncoated regions of the web 102. The powder removing assembly 118 removes the dry powder 114 in the desired areas such that these uncoated areas or regions are completely free from the dry powder 114, while the surrounding regions remain evenly coated with the dry powder 114. The uncoated pattern can be formed in the machine direction, the cross direction, or both.

After the desired areas of the dry powder 114 have been removed to create a pattern of coated and uncoated regions of the web 102, the web 102 continues to travel along the direction 104 to the heated press assembly (e.g., a bonding assembly) formed by a hot roller 120 disposed over the surface of the web 102 and a roller 122 (e.g., a roll-to-roll roller) disposed below the web 102. In some embodiments, the roller 122 can be hot or cold. In some embodiments, the web 102 can initially be passed through a heating chamber before entering the heated press assembly formed by rollers 120, 122. The heated press assembly is disposed distally from the powder removing assembly 118. The rollers 120, 122 can be calender rolls that press the dry powder 114 onto the web 102 with heat from the roller 120 to densify the active material coating onto the web 102. In particular, the heat applied by the roller 120 can soften and/or melt the binder in the powder 114 to bind the active material coating 124 to the top surface of the web 102. The force imparted by the rollers 120, 122 onto the web 102 can be regulated by a central controller and/or at the rollers 120, 122. In some embodiments, the roller 122 position can remain fixed while the roller 120 can be moved further or closer from the roller 122 to regulate the pressure imparted on the web 102 for bonding of the dry powder 114.

After passage through the heated press assembly, the active material coating 124 is strongly bonded to the top surface of the web 102. Although FIG. 4 illustrates the web 102 with a central region coated with the coating 124, it should be understood that by using the powder removing assembly 118, one or more central regions can remain uncoated and the bonded coating 124 would have the same pattern as the one generated after passage of the web 102 through or under the powder removing assembly 118 (e.g., the pattern of electrodes 50, 70 in FIG. 2 or 3, or other uncoated/coated patterns). After binding, the web 102 continues to travel along direction 104 towards and over the roller 108 at the distal end of the system 100. At this stage of the fabrication process, the web 102 can be rolled onto a core at a rewind station, slit, and assembled into a Li-ion battery.

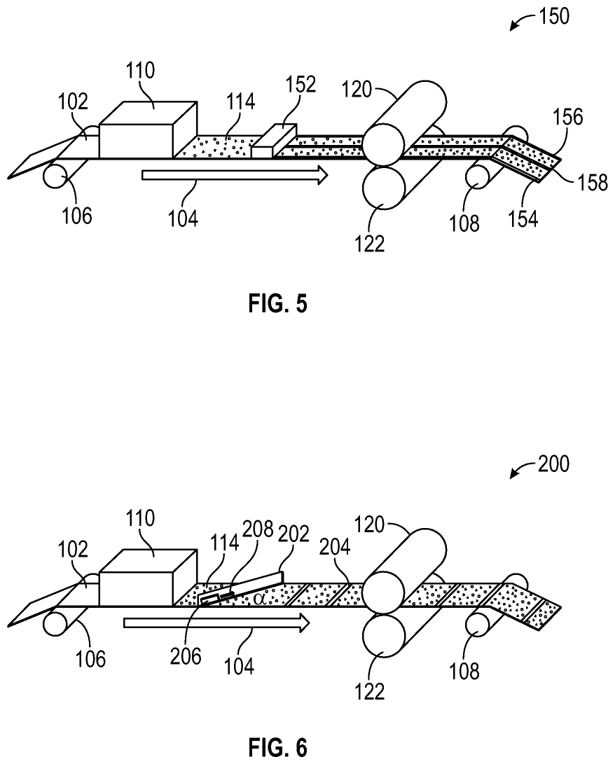

The powder removing assembly 118 of the system 100 shown in FIG. 4 can be in a variety of forms that are each capable of selectively removing the dry powder 114 from the surface of the web 102 to achieve the desired coated/uncoated pattern to be bonded to the web 102. For example, the assembly 118 can be in the form of a wiping mechanism and/or a masking mechanism. The assembly 118 can therefore create an uncoated pattern using a wiping mechanism independently, a masking mechanism independently, or a combination of wiping and masking mechanisms. In some embodiments, a vacuum assembly can be used in combination with the wiping mechanism to remove the dry powder 114 from the web 102. In embodiments including a masking mechanism, the powder removing assembly 118 is incorporated into and operates within the coating assembly 110 to selectively remove the dry powder 114 while the web 102 is being coated. This is achieved by masking the desired edge tab region from the coating process, such that the web 102 is never coated in this region. As discussed herein, the masking mechanism can be in the form of a conveyor mask and/or a stationary mask. FIGS. 5-17 illustrate embodiments of the system having different embodiments of the powder removing assembly. The systems can be substantially similar in structure and/or function to the system 100 of FIG. 4, except for the distinctions noted herein. As such, same reference numbers are used to refer to same structures.

FIG. 5 illustrates a system 150 including a powder removing assembly in the form of a wiping mechanism 152. The wiping mechanism 152 is disposed after the coating assembly 110 and operates after the web 102 has been coated with the dry powder 114. This is achieved by wiping off the dry coating powder 114 in the desired edge tab region(s) after coating has been completed and the web 102 has moved to the powder removing assembly 118. In some embodiments, the wiping mechanism 152 can be arranged across the web 102 in a substantially perpendicular orientation relative to the travel direction 104 of the web 102. In some embodiments, as illustrated by the system 200 of FIG. 6, the wiping mechanism 202 can be arranged across the web 102 at a non-perpendicular orientation relative to the travel direction 104 of the web 102. As discussed herein, the wiping mechanism 152, 202 can be in the form of a vacuum, ramps, slitters, conveyors, and/or rotators, that wipe the powder 114 off of the surface of the web 102 as the web 102 passes through and/or under the wiping mechanism 152, 202. In the orientation of FIG. 5, the wiping mechanism 152 can form uncoated regions 154, 156 along edges of the web 102, and an inner uncoated region 158 at a central area of the web 102, each oriented along the machine direction. In the orientation of FIG. 6, the wiping mechanism 202 can form uncoated regions 204 laterally across the web 102 in a spaced manner and oriented perpendicularly to the machine direction. In the embodiment of FIG. 6, the wiping mechanism 202 can include a wiping structure 206 that moves along direction 208 to wipe the powder 114 from the surface of the web 102.

Still with reference to FIG. 6, the wiping mechanism 202 is configured to form uncoated regions 204 that are perpendicular to the machine direction. The wiping structure 206 can include any of the wiping embodiments discussed herein, and traverses across the web 102 at an angle α to the machine direction. This angle α is selected based Equation 1 below:

$$cos α = \frac{{v}_{web}}{{v}_{traverse}} \qquad ( 1 )$$

where v_{web} is the linear velocity of the web 102, and vₜᵣₐᵥₑᵣₛₑ is the target velocity for the wiping mechanism traverse. Equation 1 provides a velocity triangle for deriving angle α. This relationship is critical to achieve a perpendicular strip. The condition of vₜᵣₐᵥₑᵣₛₑ>v_{web} must always be true. The range for angle α can be between about, e.g., 25-75 degrees inclusive, 25-70 degrees inclusive, 25-65 degrees inclusive, 25-60 degrees inclusive, 25-55 degrees inclusive, 25-50 degrees inclusive, 25-45 degrees inclusive, 25-40 degrees inclusive, 25-35 degrees inclusive, 25-30 degrees inclusive, 30-75 degrees inclusive, 35-75 degrees inclusive, 40-75 degrees inclusive, 45-75 degrees inclusive, 50-75 degrees inclusive, 55-75 degrees inclusive, 60-75 degrees inclusive, 65-75 degrees inclusive, 70-75 degrees inclusive, 25 degrees, 30 degrees, 35 degrees, 40 degrees. 45 degrees, 50 degrees, 55 degrees, 60 degrees, 65 degrees, 70 degrees, 75 degrees, or the like. After the wiping is complete for a particular strip, the wiping mechanism traverses back along the wiping structure 206, this time without contacting the coating 114, to the start position. The sequence can then restart for the next perpendicular strip of region 204.

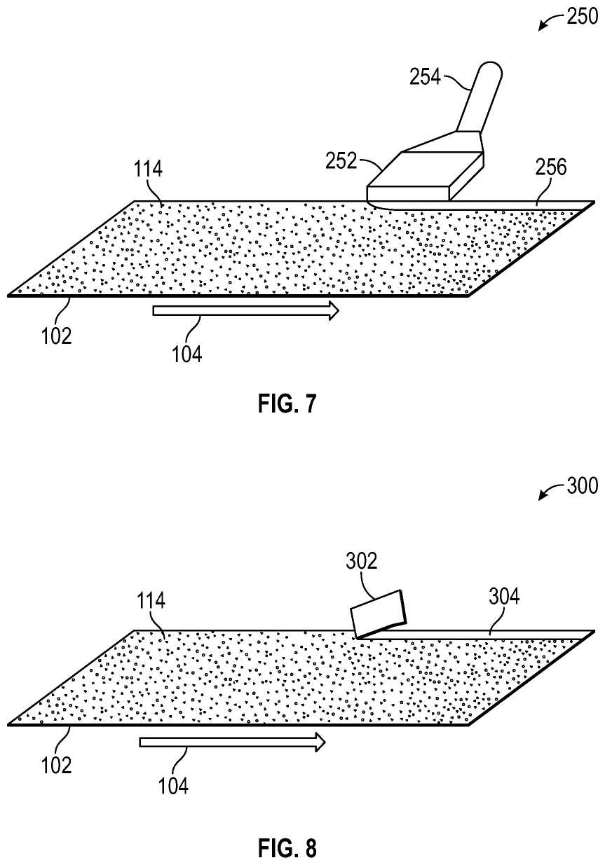

In some embodiments, the wiping mechanism can be in the form of a vacuum 252, as illustrated in the system 250 of FIG. 7. In such embodiments, a vacuum 252 with a specific nozzle geometry can be positioned at a predetermined or adjustable height above the surface of the web 102. Coupled with the correct electrostatic voltage (selected based on the magnitude of the image force), which provides enough image force to hold the coating 114 on the web 102 but is weak enough to allow for the vacuum 252 to locally remove the coating 114, the vacuum 252 removes material from the edge tab region 256 and leaves the desired coating 114 intact. A powder collection ducting 254 extending from the vacuum 252 can lead to a chamber for collecting the removed powder 114 for recycling and/or reuse. In some embodiments, the vacuum 252 can be replaced by or coupled with a blower, air knife, or similar structure, to remove the coating 114 in a precise manner. The nozzle shape can be specifically selected or designed to generate the appropriate flow field to only remove powder in the edge tab region 256.

In some embodiments, the wiping mechanism can be in the form of one or more ramps 302, as illustrated in the system 300 of FIG. 8. In such embodiments. ramp 302 wipers can be stationary wipers that rely on an angled surface to move powder 114 from the web 102 in the desired or specified places to form the edge tab region 304. In such embodiments, the ramp 302 has a surface that sits at a given/fixed angle relative to the direction 104 of the web 102 motion, e.g., a given rake angle up to 90° in reference to the direction 104. In some embodiments, the rake angle can be about 45°. The ramp 302 can be positioned such that the ramp 302 contacts the web 102 and extends into the web 102 the desired width of the edge tab region 304. The angle of the surface can be such that the coating 114 is directed towards the edge of the web 102, given the direction 104 of the web 102 motion.

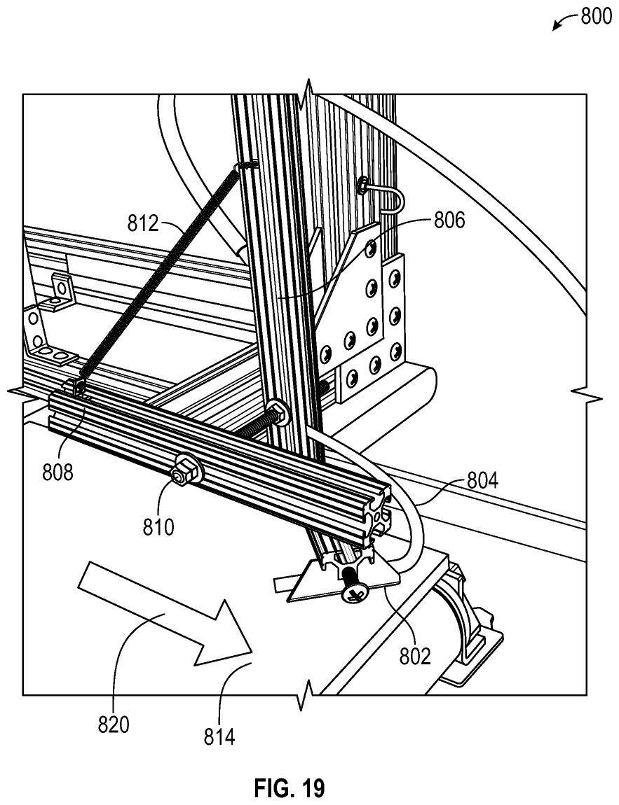

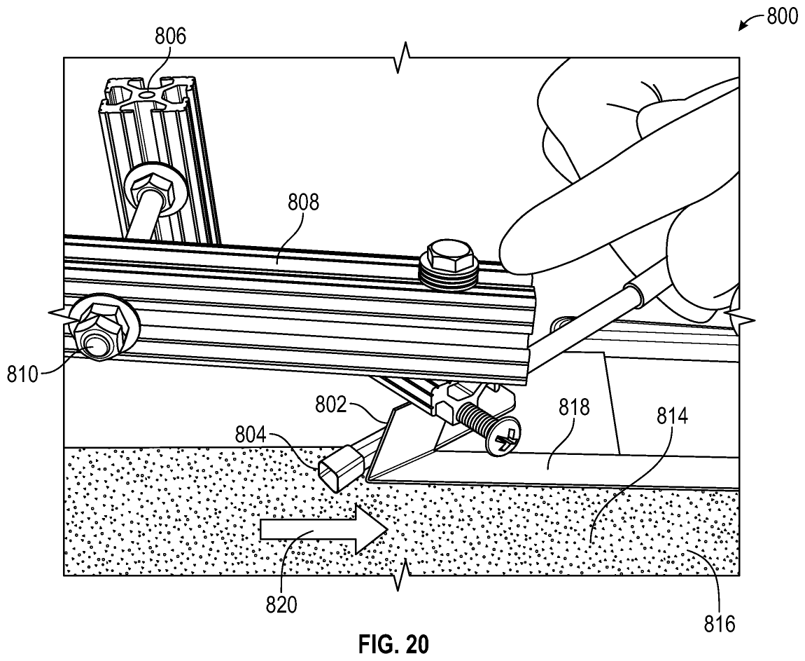

In some embodiments, the wiping mechanism can be in the form of one or more ramps 802 (e.g., wiping blades, or the like) in combination with one or more vacuums 804, as illustrated in the system 800 of FIGS. 19 and 20. In some embodiments, the ramps 802 and/or vacuums 804 can be substantially similar in structure and/or function to the vacuum 252 and ramps 302 of FIGS. 7 and 8. The system 800 generally includes a vertical support structure 806 with a beam 808 pivotally coupled to the structure 806 by a fastener 810. The fastener 810 defines the pivot point or axis of the beam 808 relative to the structure 806. One end of the beam 808 is coupled to a compression spring 812, with the opposing end of the spring 812 coupled to the structure 806. The connection between the spring 812 and the structure 806 is above the connection of the fastener 810. A wiping assembly is coupled to the opposing end of the beam 808 (relative to the spring 812). The wiping assembly includes a wiping ramp 802 disposed distally relative to a vacuum 804 (e.g., a vacuum tube). The vacuum 804 is therefore disposed directly in front of the ramp 802. In some embodiments, only the open end of the vacuum 804 can provide a suction force. In some embodiments, a length of the distal end of the tube of the vacuum 804 can include openings and/or slots for suction along a length of the tube (e.g., a distance substantially equal to the width of the ramp 802 such that suction is provided directly in front of the ramp 802).

In FIGS. 19 and 20, the system 800 is configured to wipe active material 814 from a surface of the web 816 to form the left edge tab 818 of the continuous web 816 as the web 816 moves in direction 820. Although the system 800 is shown as forming the left edge tab 818, it should be understood that a mirrored configuration could be used to form the right edge tab of the electrode. In some embodiments, a combination of both right and left assemblies can be located in the center of the web to form a central edge tab. In some embodiments, a perpendicularly oriented ramp 802 can be positioned at the center of the web to form the central edge tab. In operation, the wiping blade (i.e., the ramp 802) disturbs the active material 814 in the precise location where the edge tab 818 is desired. The spring 810 maintains a downward force on the beam 808 which, in turn, provides a downward force of the wiping assembly on the web surface to disturb, move or wipe the active material 814. The force provided by the spring 810 is selected to ensure an effective disturbing o the powder occurs without damaging the foil substrate. This disturbed powder collects in a small pile ahead of the ramp 802, and the vacuum 804 continuously removes this powder as it collects. The vacuum 804 is tuned to only remove the disturbed powder without affecting the surrounding powder, ensuring a substantially uniform line along the formed edge tab 818.

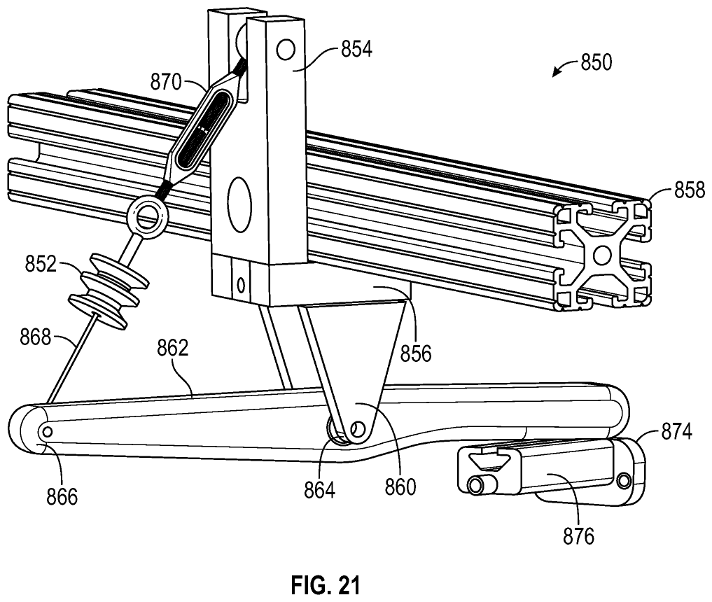

In some embodiments, the wiping mechanism of FIGS. 19 and 20 can include an adjustable spring 852, as illustrated in the system 850 of FIG. 21. The system 850 can be substantially similar in structure and/or function to the system 800, except for the distinctions noted herein. The vertical support structure can be in the form of mounting brackets 854, 856, with bracket 854 extending vertically and bracket 856 coupled to and extending perpendicularly from the bracket 854. The brackets 854, 856 can be coupled to a support beam 858 to provide stability to the system 850. The bottom of the bracket 856 can include mounting flanges 860 extending perpendicularly therefrom in a spaced manner. The mounting flanges 860 are spaced to pivotally accommodate a beam 862 therebetween. The beam 862 can be mounted with a fastener 864 which defines the pivot point of the beam 862 relative to the mounting flanges 860.

One end 866 of the beam 862 is coupled to a cable 868 that connects to the spring 852. The opposing end of the spring 852 is coupled to the bracket 854. In some embodiments, the spring 852 can be connected to the bracket 854 via, e.g., a turnbuckle 870, or the like. The opposing end 872 of the beam 862 includes the wiping assembly, i.e., the ramp 874 and vacuum 876. The system 850 operates in the same manner as the system 800, with the ramp 874 disturbing the active material coating and the vacuum 876 collecting the disturbed active material to form the tab. The turnbuckle 870 can be adjusted to tune the force exerted by the spring 852, thereby adjusting the force applied by the ramp 874 to the web surface. In some embodiments, the adjustment of the force can be automated by replacing the turnbuckle 870 with a spool mounted on a servo motor. Winding or unwinding the spool using the servo motor increases or decreases the downward force on the ramp 874. In some embodiments, the ramp and vacuum assembly can be formed from separate components (such as the system 800 of FIGS. 19 and 20). In some embodiments, the vacuum 876 and ramp 874 can be combined into one component, as shown in FIG. 21. In particular, the body of the vacuum 876 serves as the mount for the ramp 874, ensuring precise alignment between the vacuum 876 opening and the ramp 874 edge.

Although the ramps 802, 874 are used for removing all of the active material coating in the desired locations along the web surface, in some embodiments, the system can be configured to remove only a partial thickness of the active material coating in specific locations along the web surface. For example the bottommost edge of the ramp is set at a specified fixed height from the surface of the web (e.g., ranging from about 10-100 μm inclusive, 20-100 μm inclusive, 30-100 μm inclusive, 40-100 μm inclusive, 50-100 μm inclusive, 60-100 μm inclusive, 70-100 μm inclusive, 80-100 μm inclusive, 90-100 μm inclusive, 10-90 μm inclusive, 10-80 μm inclusive, 10-70 μm inclusive, 10-60 μm inclusive, 10-50 μm inclusive, 10-40 μm inclusive, 10-30 μm inclusive, 10-20 μm inclusive, 20-90 μm inclusive, 30-80 μm inclusive, 40-70 μm inclusive, 50-60 μm inclusive, 10 μm, 20 μm, 30 μm, 40 μm, 50 μm, 60 μm, 70 μm, 80 μm, 90 μm, 100 μm, or the like). The ramps are positioned in the location of the desired edge tab formation.

When the coated substrate passes under the ramp, the coated active material thickness is reduced in the location of the wiping blade. However, only a partial thickness of the active material is removed, with the remaining thickness on the web passing under and away from the ramp. In some embodiments, the active material thickness can be reduced by alternative assemblies, e.g., a counter rotating vacuum roller, or the like. The electrode subsequently passes through a calender system (as described above with respect to system 150). After the calendering process, the region of the electrode with a reduced coating thickness has greatly reduced adhesion to the web due to a decrease in load from the calender roller (i.e., less force on the active material due to less or no contact with the calender roll). In areas of the web having a thicker coating of the active material, the calender roll creates a strong adhesion to the web. The entire electrode is subsequently exposed to another material removal system, e.g., compressed air, vacuum, a wiping blade, combinations thereof, or the like, which can remove the powder with reduced adhesion, forming the desired edge tab region. Thus, only a partial reduction of the active material thickness in areas of the web can be used to create the edge tab region, with the lack of adhesion being used in a subsequent process to remove the non-adhered material to form the edge tab regions.

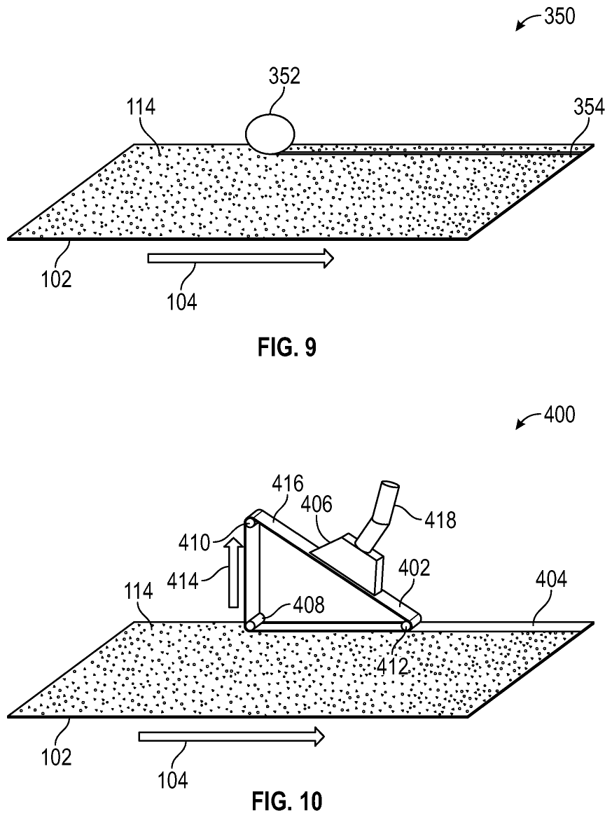

In some embodiments, the wiping mechanism can be in the form of one or more rotary blades or slitters 352, as illustrated in the system 350 of FIG. 9. In such embodiments, the slitters 352 can include a thin blade or rotary blade to slit the powder 114. In such embodiments, the blade rests on the web 102 and slits the coating 114 at the desired location where the coating 114 meets the edge 354 tab. There is only enough downward force applied by the slitters 352 at the blade to slit the coating 114 and not the web 102, thereby preventing damage to the web 102 itself. This sets a precise edge 354 for where the tab starts. A vacuum can be positioned distally or downwardly from the slitter 352 to remove the powder 114 that has been sectioned off by the blade of the slitter 354 (e.g., from the edge 354 to the outer edge of the web 102). The slitters 352 can thereby be used to identify and form a precise edge 354 along which the uncoated region will be formed by another mechanism.

In some embodiments, wiping mechanism can be in the form of a conveyor system having one or more conveyor wipers 402 that are belt-based, as illustrated in the system 400 of FIG. 10. In some embodiments, the conveyor system can be in the form of a perpendicular or parallel wiping belt 402. In such embodiments, a conveyor belt system can run perpendicular or parallel to the direction 104 of the web 102 motion. The coating on the belt can be a low friction material with the ability to pick up powder 114, such as a densely packed, short bristle brush or a felt material that holds powder 114 in its fibers. The belt extends into the web 102 the desired width of the edge tab region 404. A vacuum 406 collects the removed powder 416 and thoroughly cleans the belt surface on the return leg before the belt makes contact with the web 102 again. In embodiments having a parallel belt, the belt can run in the same direction as the web 102 or opposite direction of the web 102. As illustrated in FIG. 10, the conveyor system can include multiple rollers 408, 410, 412 that maintain the belt (e.g., wipers 402) under tension and traveling along direction 414 in a clockwise or counterclockwise direction. The belt thereby collects the predetermined amount of powder 114 from the web 102 and lifts the removed powder 416 along the belt surface, with the removed powder 416 collected with the vacuum 406 to allow the cleaned belt to travel in the direction 414 to remove additional powder 114 from the web 102 in a continuous operation. Powder collection ducting 418 extends from the vacuum 406 to collect the removed powder 416 in a chamber for recycling and/or reuse.

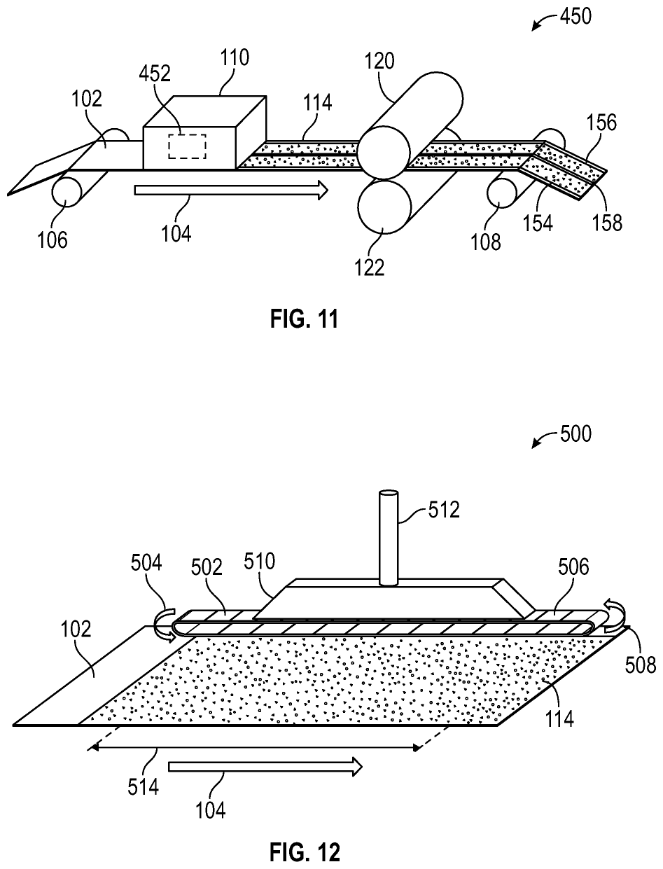

In some embodiments, the powder removing mechanism can be a masking mechanism 452 incorporated into and operating within the coating assembly 110 to selectively remove the dry powder 114 while the moving web 102 is being continuously coated, as illustrated in the system 450 of FIG. 11. Such removal of the powder 114 can be achieved by masking the desired edge tab region from the coating process, such that the web 102 is never coated in this region. As discussed herein, the masking mechanism 452 can be in the form of a conveyor mask and/or a stationary mask.

In some embodiments, the masking mechanism can be in the form of a vacuum-assisted conveyor mask, as illustrated in the system 500 of FIG. 12. In such embodiments, a conveyor belt 502 can be continuously rotated against the surface of the web 102. The surface or coating of the belt 502 can be low friction or includes features to assist with lifting and removing the powder 506 from the web 102 to form the uncoated edge tab region 508. The belt 502 is rotated continuously along direction 504 to remove the powder 506, and a vacuum 510 can be used to remove the powder 506 from the belt 502 such that the cleaned belt 502 can be used again to form the edge tab region 508. Ducting 512 can be used to remove the collected powder 506 for reuse and/or recycling. Such system 500 allows for the coated area 514 to remain while the uncoated pattern is formed on the web 102.

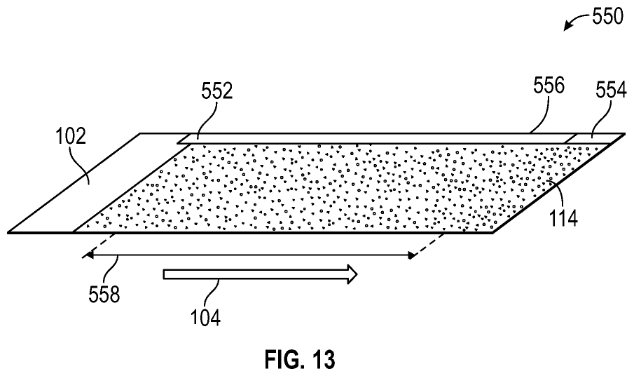

In some embodiments, the masking mechanism can be in the form of a vacuum-assisted stationary mask, as illustrated in the system 550 of FIG. 13. In such embodiments, a strip of plate 552 can be used cover the width of the desired edge tab region 554 inside of the coating chamber 110. A vacuum system (similar to the vacuum systems discussed herein for other embodiments) can be oriented such that the powder 556 which lands on the mask can be continuously removed via the vacuum system to avoid powder build-up on the mask. Such system allows for the coated area 558 to remain while the uncoated pattern is formed on the web 102.

Although the systems discussed herein illustrate the web 102 oriented and moving in a direction 104 parallel to the floor, with the coating 114 on top of the web 102, it should be understood that the web 102 can be in any orientation between 0° and 90°, inclusive, in reference to the floor. For example, the system 600 of FIG. 14 can be substantially similar to the system 150 of FIG. 5, except the orientation of the entire system 600 is vertical. However, it should be understood that other angles between 0° and 90°, inclusive, of the entire system and or web 102 could be used.

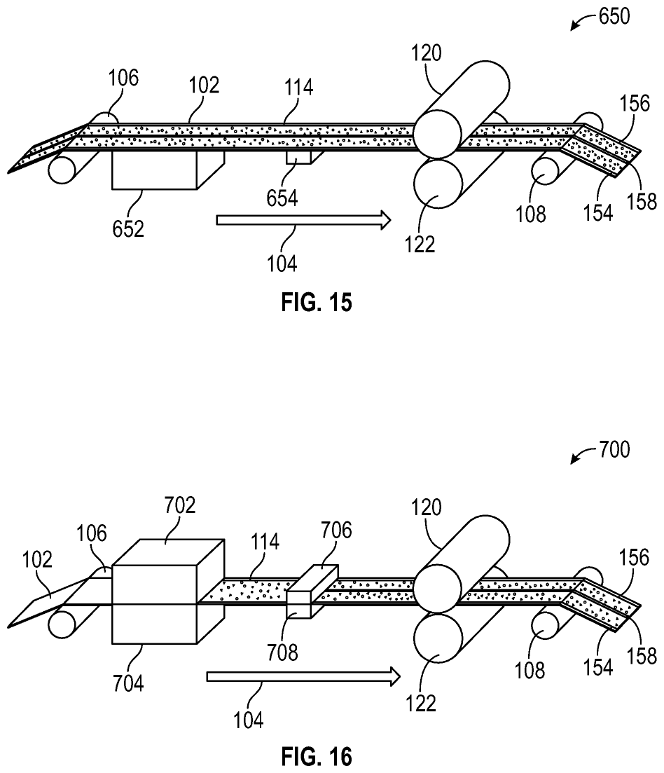

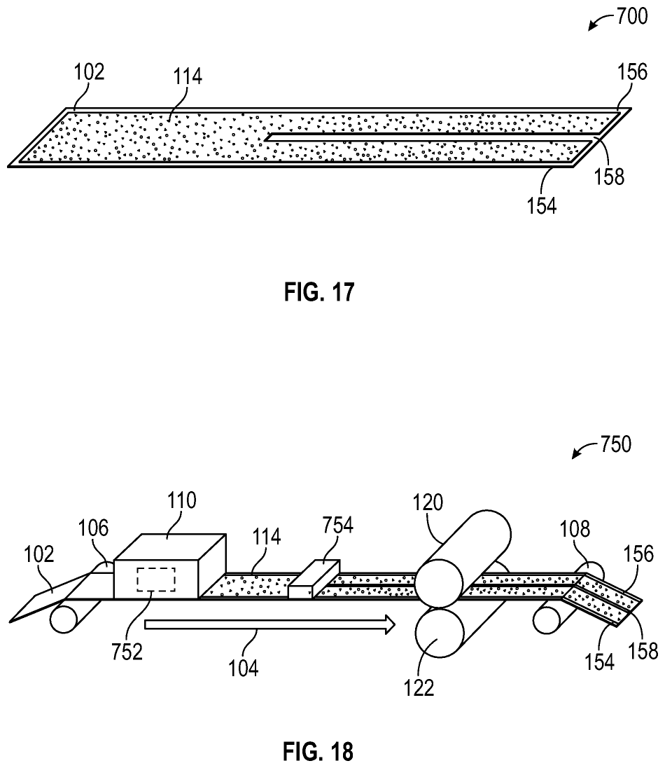

Although the systems discussed herein illustrate the web 102 being coated along only one surface (e.g., a top surface), in some embodiments, the systems can be configured for coating powder and generating a coating pattern on one or both sides of the web 102, sequentially or simultaneously. For example, FIG. 15 illustrates a system 650 including a coating assembly 652 disposed adjacent to the bottom surface of the web 102 such that the web 102 can be coated from the bottom rather than the top. In such embodiments, the powder removing assembly 654 can also be disposed along the bottom of the web 102. The web 102 illustrated in FIG. 15 was previously coated along one surface, and was flipped to coat and form an uncoated pattern along the opposing surface. As another example, FIG. 16 illustrates a system 700 including a coating assembly 702 disposed over a top surface of the web 102, and a coating assembly 704 disposed adjacent to a bottom surface of the web 102, such that both surfaces of the web 102 can be coated simultaneously. In such embodiments, the system 700 also includes a first powder removing assembly 706 disposed over the top surface of the web 102, and a second powder removing assembly 708 disposed adjacent to the bottom surface of the web 102, such that an uncoated pattern can be simultaneously formed on both sides of the web 102. FIG. 17 illustrates a bottom side of the web 102 with the uncoated regions 154, 156, 158 formed thereon. In some embodiments, the system 700 can be used to form the same uncoated region pattern on both surfaces of the web 102, or can be used to form different uncoated region patterns on the top and bottom surfaces of the web 102, depending on manufacturing guidelines.

The masking and/or wiping mechanisms discussed herein can be used to recover the removed dry powder 114 for recycling and reuse for further coating of the same or different web 102. In some embodiments, one or more of the masking and/or wiping mechanisms can be combined to generate uncoated coating patterns in a batter electrode. For example, FIG. 18 illustrates a system 750 including a masking mechanism 752 incorporated into the coating assembly 110 and a wiping mechanism 754 positioned distally from the coating assembly 110. The system 750 therefore allows for a combined masking and wiping operation to create the uncoated pattern on the web 102. In some embodiments, the masking mechanism 752 can be used to produce outer strips of uncoated regions 154, 156, and the wiping mechanism 754 can be used to produce the inner strip uncoated region 158. However, it should be understood that any combination of wiping and masking can be used during production of the electrode. For example, in some embodiments, the masking mechanism 752 can be used to produce the majority of the uncoated regions and the wiping mechanism 754 can be used to refine the formed uncoated regions for improved accuracy of the resulting pattern.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. An electrode for a battery, the electrode comprising:
an electrically conductive substrate defining a first surface and an opposing second surface; and
a pattern of an active material coating formed on at least one of the first surface or the second surface of the electrically conductive substrate, the pattern including coated and uncoated areas;
wherein the pattern of the coated and the uncoated areas is formed by:
depositing an active material dry powder onto at least one of the first surface or the second surface of the electrically conductive substrate via electrostatic spray deposition during movement of the electrically conductive substrate;
selectively removing at least a portion of the active material dry powder from at least one of the first surface or the second surface of the electrically conductive substrate with a powder removing assembly to create the uncoated areas of the pattern; and
bonding the active material dry powder to at least one of the first surface or the second surface of the electrically conductive substrate to create the coated areas of the pattern.

2. The electrode of claim 1, wherein the electrically conductive substrate is an aluminum foil substrate.

3. The electrode of claim 1, wherein the first and second surfaces of the electrically conductive substrate are substantially planar or flat.

4. The electrode of claim 1, wherein the pattern of the coated and uncoated areas is formed by simultaneously depositing the active material dry powder onto both the first surface and the second surface of the electrically conductive substrate via electrostatic spray deposition, simultaneously selectively removing at least the portion of the active material dry powder from both the first surface and the second surface of the electrically conductive substrate with the powder removing assembly to create the uncoated areas of the pattern on both the first surface and the second surface.

5. The electrode of claim 1, wherein the powder removing assembly includes a wiping mechanism configured to remove at least the portion of the active material dry powder from at least one of the first surface or the second surface of the electrically conductive substrate.

6. The electrode of claim 1, wherein the powder removing assembly includes a wiping mechanism configured to disturb or move at least a portion of the active material dry powder from at least one of the first surface or the second surface of the electrically conductive substrate, and further includes a vacuum configured to remove the disturbed or moved active material dry powder.

7. The electrode of claim 1, wherein the powder removing assembly includes a masking mechanism configured to cover an area of the electrically conductive substrate corresponding with the uncoated areas of the pattern.

8. The electrode of claim 1, wherein the pattern includes the uncoated areas in a cross direction of the electrically conductive substrate.

9. A system for battery electrode fabrication, comprising:
a coating assembly configured to deposit an active material dry powder onto at least one of a first surface or an opposing second surface of an electrically conductive substrate via electrostatic spray deposition while the electrically conductive substrate moves or passes through or under the coating assembly;
a powder removing assembly configured to selectively remove at least a portion of the active material dry power from at least one of the first surface or the second surface of the electrically conductive substrate to create a pattern of the active material dry powder having coated and uncoated areas; and
a bonding assembly configured to bond the active material dry powder to at least one of the first surface or the second surface of the electrically conductive substrate.

10. The system of claim 9, wherein the electrically conductive substrate is an aluminum foil substrate.

11. The system of claim 9, wherein the pattern includes the uncoated areas oriented along a cross direction of the electrically conductive substrate.

12. The system of claim 9, wherein the pattern includes the uncoated areas oriented along a machine direction of the electrically conductive substrate.

13. The system of claim 9, wherein the powder removing assembly includes a masking mechanism incorporated into the coating chamber.

14. The system of claim 9, wherein the powder removing assembly includes a wiping mechanism disposed distally from the coating chamber.

15. The system of claim 9, wherein the powder removing assembly includes both a masking mechanism incorporated into the coating chamber and a wiping mechanism disposed distally from the coating chamber.

16. The system of claim 9, wherein the coating assembly is configured to simultaneously deposit the active material dry powder on both the first surface and the second surface of the electrically conductive substrate, and the powder removing assembly is configured to simultaneously selectively remove at least the portion of the active dry powder from both the first surface and the second surface of the electrically conductive substrate to create the pattern of the active material dry powder having coated and uncoated areas on both the first surface and the second surface.

17. The system of claim 9, wherein the powder removing assembly is a wiping mechanism including a vacuum including a nozzle disposed above at least one of the first surface or the second surface of the electrically conductive substrate and configured to selectively remove the active material dry powder to form the uncoated areas of the pattern.

18. The system of claim 9, wherein the powder removing assembly is a wiping mechanism including an angled ramp configured to direct the active material dry powder off of the electrically conductive substrate to form the uncoated areas of the pattern.

19. The system of claim 9, wherein the powder removing assembly includes a wiping mechanism including a ramp configured to disturb or move at least a portion of the active material dry powder from the electrically conductive substrate, and further includes a vacuum configured to remove the disturbed or moved active material dry powder.

20. The system of claim 9, wherein the powder removing assembly is a wiping mechanism including a rotary slitter configured to form a slit in the active material dry powder to designate an edge of the uncoated areas to be formed in the active material dry powder.

21. The system of claim 9, wherein the power removing assembly is a wiping mechanism including a conveyor system with one or more belts configured to contact and remove the active material dry powder from the electrically conductive substrate.

22. A method of battery electrode fabrication, comprising:
continuously passing an electrically conductive substrate through or under a coating assembly to deposit an active material dry powder onto at least one of a first surface or a second surface of the electrically conductive substrate via electrostatic spray deposition during movement of the electrically conductive substrate;
selectively removing at least a portion of the active material dry powder from at least one of the first surface or the second surface of the electrically conductive substrate with a powder removing assembly to create a pattern of the active material dry powder having coated and uncoated areas; and
bonding the active material dry powder to at least one of the first surface or the second surface of the electrically conductive substrate with a bonding assembly.
